(19) United States
(12) Patent Application Publication
(10) Pub. No.: US 2015/0195113 A1
(43) Pub. Date: Jul. 9, 2015

(54) METHOD OF DETERMINING SUB FRAME IN WIRELESS COMMUNICATION SYSTEM

(71) Applicant: LG ELECTRONICS INC., Seoul (KR)

(72) Inventors: Sunam Kim, Anyang-si (KR); Jaehoon Chung, Anyang-si (KR); Binchul Ihm, Anyang-si (KR); Youngsoo Yuk, Anyang-si (KR)

(73) Assignee: LG ELECTRONICS INC., Seoul (KR)

(21) Appl. No.: 14/408,523

(22) PCT Filed: May 24, 2013
(86) PCT No.: PCT/KR2013/004565

§ 371 Date: Dec. 16, 2014

Related U.S. Application Data
(60) Provisional application No. 61/660,788, filed on Jun. 17, 2012.

(51) Int. Cl. H04L 27/26; H04W 72/04

(52) U.S. Cl. CPC H04L 27/2602; H04W 72/0446

(57) ABSTRACT

A disclosure of the present invention provides a method of determining subframes. According to the method, subframe configuration information on a plurality of subframes is received from a base station. Here, each of the subframes may include a plurality of OFDM symbols, each of the OFDM symbols may include a cyclic prefix (CP) that is equal to or longer than zero in length, and the CP length may be the same across the plurality of OFDM symbols in a subframe. Also, according to the method, the CP length of a subframe to be received is determined based on the subframe configuration information. Here, the subframe configuration information may indicate that the CP length of each of the subframe is any one of a first CP length and a second CP length.

### BACKGROUND OF THE INVENTION

1. Field of the invention

The present invention relates to a method of determining a sub frame in a wireless communication system.

2. Related Art

The next-generation multimedia wireless communication systems which are recently being actively researched are required to process and transmit various pieces of information, such as video and wireless data as well as the initial voice-centered services.

The object of the wireless communication system is to establish reliable communications between a number of users irrespective of their positions and mobility. However, a wireless channel has abnormal characteristics, such as path loss, noise, a fading phenomenon due to multi-path, inter-symbol interference (ISI), and the Doppler Effect resulting from the mobility of a user equipment. A variety of techniques are being developed in order to overcome the abnormal characteristics of the wireless channel and to increase the reliability of wireless communication.

Meanwhile, the quantity of data transmitted and received through the wireless communication system has rapidly increased in recent years. Various technologies have been developed in order to satisfy a high required data quantity. A carrier aggregation (CA) technology, a cognitive radio (CR) technology, and the like for efficiently using more frequency bands have been under a research. Further, a multiple antenna technology, a multiple base station cooperation technology, and the like for increasing a data capacity have been researched in a limited frequency band. That is, consequently, the wireless communication system will be evolved so that the density of nodes which may access the vicinity of a user increases. The performance of the wireless communication system in which the density of the nodes is high may be more improved by cooperation between the nodes. That is, the wireless communication system in which the respective nodes cooperates with each other has more excellent performance than a wireless communication system in which each node operates as a base station (BS), an advanced BS (ABS), a node-B (NB), an eNode-B (eNB), an access point (AP), and the like.

In order to enhance the performance of the wireless communication system, a distributed multi node system (DMNS) including a plurality of nodes in a cell may be applied. The DMNS may include a distributed antenna system (DAS), a radio remote head (RRH), and the like. Further, a standardization work for applying to the DMNS various multiple-input multiple-output (MIMO) techniques and cooperative communication techniques which have been already developed or can be applied henceforward is in progress.

### SUMMARY OF THE INVENTION

Accordingly, an object of the present invention is to provide a method for efficiently operating a multiple distributed node system, for example, a distributed antenna system.

To achieve the objection, according to the one embodiment of the present specification, there is provided a method for determining subframes. The method may be performed by a user equipment (UE) and comprise: receiving from a base station subframe configuration information on a plurality of subframes. Here, each of the plurality of subframes includes a plurality of OFDM symbols, each of the plurality of OFDM symbols includes a cyclic prefix (CP) that is equal to or longer than zero in length, and the CP length is the same in a plurality of OFDM symbols of the subframe. The method may further comprise: determining a CP length of a subframe to be received based on the subframe configuration information. Here, the subframe configuration information indicates that the CP length of each of the plurality of subframes is any one of a first CP length and a second CP length.

The subframe configuration information may include a plurality of bits and each of the plurality of bits may indicate the CP length of each of the plurality of subframes.

According to the method, subframe pattern information may be further received from the base station. Here, the subframe pattern information includes a plurality of patterns for the CP lengths of the plurality of subframes and the subframe configuration information indicates one of the plurality of patterns.

The first CP length may be longer than the second CP length.

To achieve the objection, according to the one embodiment of the present specification, there is provided a method for determining subframes in a distributed antenna system. The method may be performed by a user equipment (UE) and may comprise: receiving a primary synchronization signal (PSS) and a secondary synchronization signal (SSS) from a cell by the distributed antenna system; and receiving subframe configuration information. Here, a CP type applied to each of a specific subframe and other subframes in a radio frame is determined based on the SSS and the subframe configuration information.

The CP type applied to the specific frame may be different from the CP type applied to the other subframes.

If the CP types are different from each other, the specific subframe may used for a first cell and the other subframes are used for a second cell. Here, the first cell may be a cell formed by a plurality of distributed antenna nodes, and the second cell may be a cell formed by each antenna node.

The subframe configuration information may include a bitmap indicating the applied CP type. Alternatively, the subframe configuration information may be an index indicating at least one in a table for the applied CP type.

Meanwhile, to achieve the objection, according to the one embodiment of the present specification, there is provided a user equipment (UE) for a distributed antenna system. The UE may comprise: a radio frequency (RF) unit which transmits or receives a radio signal; and a processor connected with the RF unit. Here, the processor unit is configured to acquire a type of a cyclic prefix (CP) applied to a subframe in the radio frame, identify that a first type of CP is applied to a specific subframe and a second type of CP is applied to other subframe in a radio frame, then identify the specific frame as a first cell and the other subframe as a second cell.

The first cell may be a cell formed by a plurality of distributed antenna nodes, and the second cell may be a cell formed by each antenna node.

The CP type may be acquired through a secondary synchronization signal (SSS) and subframe configuration information received from a cell by the distributed antenna system.

Meanwhile, to achieve the objection, according to the one embodiment of the present specification, there is provided a base station in a distributed antenna system. The base station may comprise: a processor unit controlling each antenna node. Here, the processor unit controls the each antenna node thereby forming a first cell by at least one antenna node and forming a second cell by antenna nodes together. Also, the processor unit is configured to apply a first type of CP to a specific subframe in a radio frame to be used for a first cell and a second type of CP to other subframes to be used for a second cell.

The antenna node through which the subframe configuration information is transmitted may be an antenna node that forms the second cell. The antenna node that forms the first cell may be an antenna node that performs a related operation of tracking area update or transmits system information.

According to the present invention, cells can be flexibly operated by using an antenna node in a distributed antenna system (DAS). Further, a frame can be dynamically changed. Accordingly, configurations of base stations and/or cells can be positively changed depending on a change in the number of user equipments, a required data traffic quantity, a motion of a target terminal, and the like and system efficiency can be maximized.

### BRIEF DESCRIPTION OF THE DRAWINGS

FIG. 1 illustrates a wireless communication system.

FIG. 2 illustrates a structure of a radio frame in 3GPP LTE.

FIG. 3 illustrates an example in which a transmission signal is changed depending on a general channel environment.

FIG. 4 is an exemplary diagram illustrating a resource grid for one uplink or downlink slot in the 3GPP LTE.

FIG. 5 illustrates a structure of a downlink subframe.

FIG. 6 illustrates a structure of an uplink subframe in the 3GPP LTE.

FIG. 7 illustrates a frame structure for transmitting a synchronization signal in an FDD frame in the related art.

FIG. 8 illustrates that two sequences in a logic region are interleaved and mapped in a physical region.

FIG. 9 illustrates an example of a frame structure in which a synchronization signal is transmitted in a TDD frame in the related art.

FIG. 10 illustrates one example of the distributed antenna system.

FIG. 11 illustrates advantages of the distributed antenna system.

FIG. 12 illustrates an operation example of the distributed antenna system.

FIG. 13 illustrates a radio frame structure according to the embodiment of the present invention.

FIG. 14 illustrates a radio frame structure according to another embodiment of the present invention.

FIG. 15 illustrates a scheme using subframe configuration information according to an embodiment of the present invention.

FIG. 16 is a flowchart illustrating a process of determining, a UE, subframe configuration according to an embodiment of the present invention.

FIG. 17 is a block diagram illustrating a wireless communication system to implement an embodiment of the present invention.

### DESCRIPTION OF EXEMPLARY EMBODIMENTS

It should be noted that technological terms used herein are merely used to describe a specific embodiment, but not to limit the present invention. Also, unless particularly defined otherwise, technological terms used herein should be construed as a meaning that is generally understood by those having ordinary skill in the art to which the invention pertains, and should not be construed too broadly or too narrowly. Furthermore, if technological terms used herein are wrong terms unable to correctly express the spirit of the invention, then they should be replaced by technological terms that are properly understood by those skilled in the art. In addition, general terms used in this invention should be construed based on the definition of dictionary, or the context, and should not be construed too broadly or too narrowly.

Incidentally, unless clearly used otherwise, expressions in the singular number include a plural meaning. In this application, the terms “comprising” and “including” should not be construed to necessarily include all of the elements or steps disclosed herein, and should be construed not to include some of the elements or steps thereof, or should be construed to further include additional elements or steps.

The terms used herein including an ordinal number such as first, second, etc. can be used to describe various elements, but the elements should not be limited by those terms. The terms are used merely to distinguish an element from the other element. For example, a first element may be named to a second element, and similarly, a second element may be named to a first element.

In case where an element is “connected” or “linked” to the other element, it may be directly connected or linked to the other element, but another element may be existed therebetween. On the contrary, in case where an element is “directly connected” or “directly linked” to another element, it should be understood that any other element is not existed therebetween.

Hereinafter, preferred embodiments of the present invention will be described in detail with reference to the accompanying drawings, and the same or similar elements are designated with the same numeral references regardless of the numerals in the drawings and their redundant description will be omitted. In describing the present invention, moreover, the detailed description will be omitted when a specific description for publicly known technologies to which the invention pertains is judged to obscure the gist of the present invention. Also, it should be noted that the accompanying drawings are merely illustrated to easily explain the spirit of the invention, and therefore, they should not be construed to limit the spirit of the invention by the accompanying drawings. The spirit of the invention should be construed as being extended even to all changes, equivalents, and substitutes other than the accompanying drawings.

A wireless device may be fixed or mobile, and may be referred to as another terminology, such as a terminal, a mobile terminal (MT), a user equipment(UE), a mobile equipment (ME), a mobile station (MS), a user terminal (UT), a subscriber station (SS), a handheld device, an access terminal (AT), etc.

A base station (BS) is generally a fixed station that communicates with the UE and may be referred to as another terminology, such as an evolved Node-B (eNB), a base transceiver system (BTS), an access point, etc.

The following technique may be used for various wireless communication systems such as code division multiple access (CDMA), a frequency division multiple access (FDMA), time division multiple access (TDMA), orthogonal frequency division multiple access (OFDMA), single carrier-frequency division multiple access (SC-FDMA), and the like. The CDMA may be implemented as a radio technology such as universal terrestrial radio access (UTRA) or CDMA2000. The TDMA may be implemented as a radio technology such as a global system for mobile communications (GSM)/general packet radio service (GPRS)/enhanced data rates for GSM evolution (EDGE). The OFDMA may be implemented by a radio technology such as institute of electrical and electronics engineers (IEEE) 802.11 (Wi-Fi), IEEE 802.16 (WiMAX), IEEE 802.20, E-UTRA (Evolved UTRA), and the like. IEEE 802.16m, an evolution of IEEE 802.16e, provides backward compatibility with a system based on IEEE 802.16e. The UTRA is part of a universal mobile telecommunications system (UMTS). 3rd generation partnership project (3GPP) long term evolution (LTE) is part of an evolved UMTS (E-UMTS) using the E-UTRA, which employs the OFDMA in downlink and the SC-FDMA in uplink. LTE-advanced (LTE-A) is an evolution of 3GPP LTE.

Hereinafter, for clarification, LTE-A will be largely described, but the technical concept of the present invention is not meant to be limited thereto.

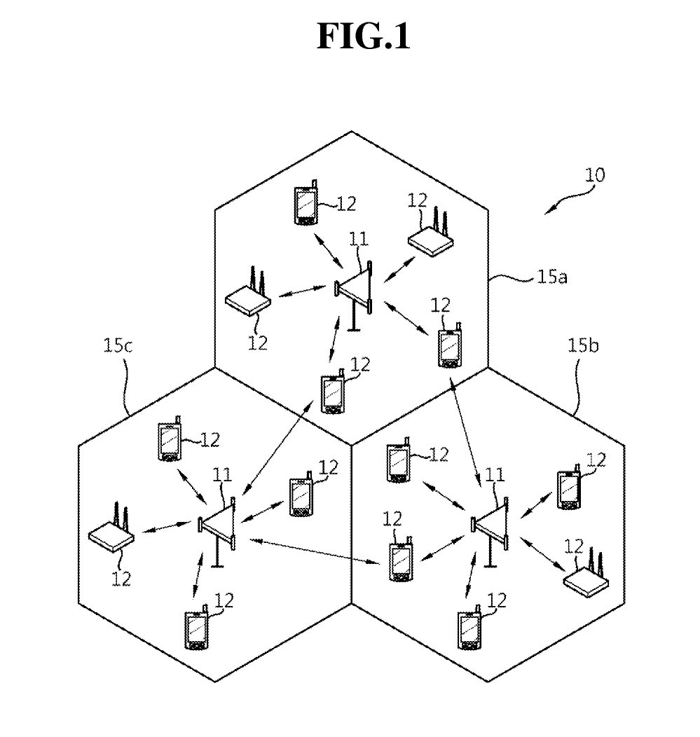

FIG. 1 shows a wireless communication system.

The wireless communication system 10 includes at least one base station (BS) 11. Respective BSs 11 provide a communication service to particular geographical areas 15a, 15b, and 15c (which are generally called cells). Each cell may be divided into a plurality of areas (which are called sectors). A user equipment (UE) 12 may be fixed or mobile and may be referred to by other names such as mobile station (MS), mobile user equipment (MT), user user equipment (UT), subscriber station (SS), wireless device, personal digital assistant (PDA), wireless modem, handheld device. The BS 11 generally refers to a fixed station that communicates with the UE 12 and may be called by other names such as evolved-NodeB (eNB), base transceiver system (BTS), access point (AP), etc.

The terminal generally belongs to one cell and the cell to which the terminal belong is referred to as a serving cell. A base station that provides the communication service to the serving cell is referred to as a serving BS. Since the wireless communication system is a cellular system, another cell that neighbors to the serving cell is present. Another cell which neighbors to the serving cell is referred to a neighbor cell. A base station that provides the communication service to the neighbor cell is referred to as a neighbor BS. The serving cell and the neighbor cell are relatively decided based on the terminal.

Hereinafter, a downlink means communication from the base station 20 to the terminal 10 and an uplink means communication from the terminal 10 to the base station 20. In the downlink, a transmitter may be a part of the base station 20 and a receiver may be a part of the terminal 10. In the uplink, the transmitter may be a part of the terminal 10 and the receiver may be a part of the base station 20.

Meanwhile, the wireless communication system may be any one of a multiple-input multiple-output (MIMO) system, a multiple-input single-output (MISO) system, a single-input single-output (SISO) system, and a single-input multiple-output (SIMO) system. The MIMO system uses a plurality of transmit antennas and a plurality of receive antennas. The MISO system uses a plurality of transmit antennas and one receive antenna. The SISO system uses one transmit antenna and one receive antenna. The SIMO system uses one transmit antenna and one receive antenna. Hereinafter, the transmit antenna means a physical or logical antenna used to transmit one signal or stream and the receive antenna means a physical or logical antenna used to receive one signal or stream.

Meanwhile, the wireless communication system may be generally divided into a frequency division duplex (FDD) type and a time division duplex (TDD) type. According to the FDD type, uplink transmission and downlink transmission are achieved while occupying different frequency bands. According to the TDD type, the uplink transmission and the downlink transmission are achieved at different time while occupying the same frequency band. A channel response of the TDD type is substantially reciprocal. This means that a downlink channel response and an uplink channel response are approximately the same as each other in a given frequency area. Accordingly, in the TDD based wireless communication system, the downlink channel response may be acquired from the uplink channel response. In the TDD type, since an entire frequency band is time-divided in the uplink transmission and the downlink transmission, the downlink transmission by the base station and the uplink transmission by the terminal may not be performed simultaneously. In the TDD system in which the uplink transmission and the downlink transmission are divided by the unit of a subframe, the uplink transmission and the downlink transmission are performed in different subframes.

Hereinafter, the LTE system will be described in detail.

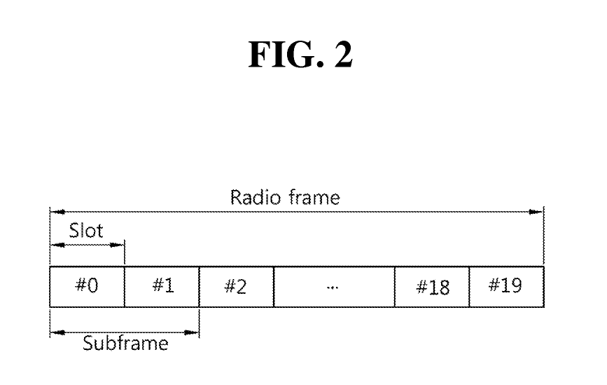

FIG. 2 shows a downlink radio frame structure in 3rd generation partnership project (3GPP) long term evolution (LTE).

The section 5 of 3GPP TS 36.211 V8.2.0 (2008-03) “Evolved Universal Terrestrial Radio Access (E-UTRA); Physical Channels and Modulation (Release 8)” may be incorporated herein.

Referring to FIG. 2, the radio frame is composed of ten subframes, and one subframe is composed of two slots. The slots in the radio frame are designated by slot numbers from 0 to 19. The time at which one subframe is transmitted is referred to as a transmission time interval (TTI). The TTI may be called as a scheduling unit for data transmission. For example, the length of one radio frame may be 10 ms, the length of one subframe may be 1 ms and the length of one slot may be 0.5 ms.

The structure of the radio frame is merely an example, and the number of subframes included in the radio frame, the number of slots included in the subframe, etc. may be variously modified.

Although it is described that one slot includes plural OFDM symbols for example, the number of OFDM symbols included in one slot may vary depending on a length of a cyclic prefix (CP).

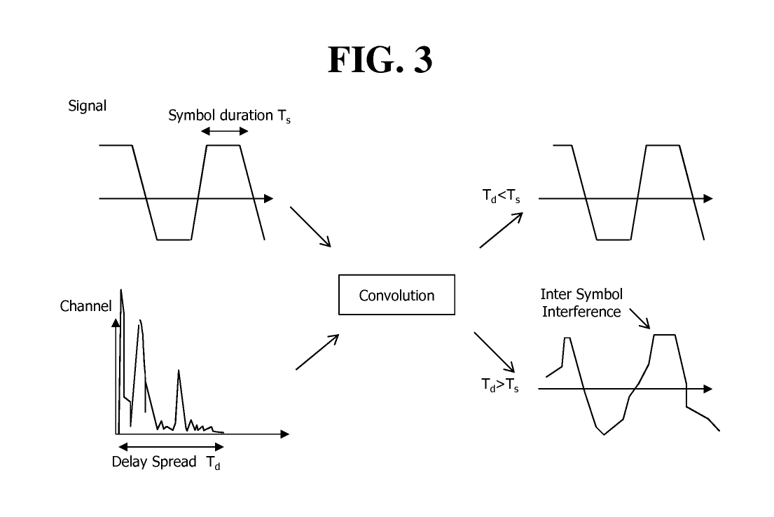

FIG. 3 illustrates an example in which a transmission signal is changed depending on a general channel environment.

As known with reference to FIG. 3, it is assumed that a signal having an OFDM symbol period Tₛ is transmitted. In this case, it is assumed that the signal suffers from a channel environment having a delay diffusion of Td, and the signal and the channel environment are subjected to a convolution.

If T_{d}<Tₛ a symbol period is just a little lengthened. However, if T_{d}>Tₛ inter-symbol interference (ISI) occurs.

A protection section is preferably configured at a start position of each OFDM symbol in order to remove the ISI. A cyclic prefix may be required in order to configure the protection section.

The CP is inserted by duplicatively inserting samples positioned at the end of each OFDM symbol into a front portion of the symbol. In regard to the length of the CP, in 3GPP LTE, a normal CP and an extended CP are defined.

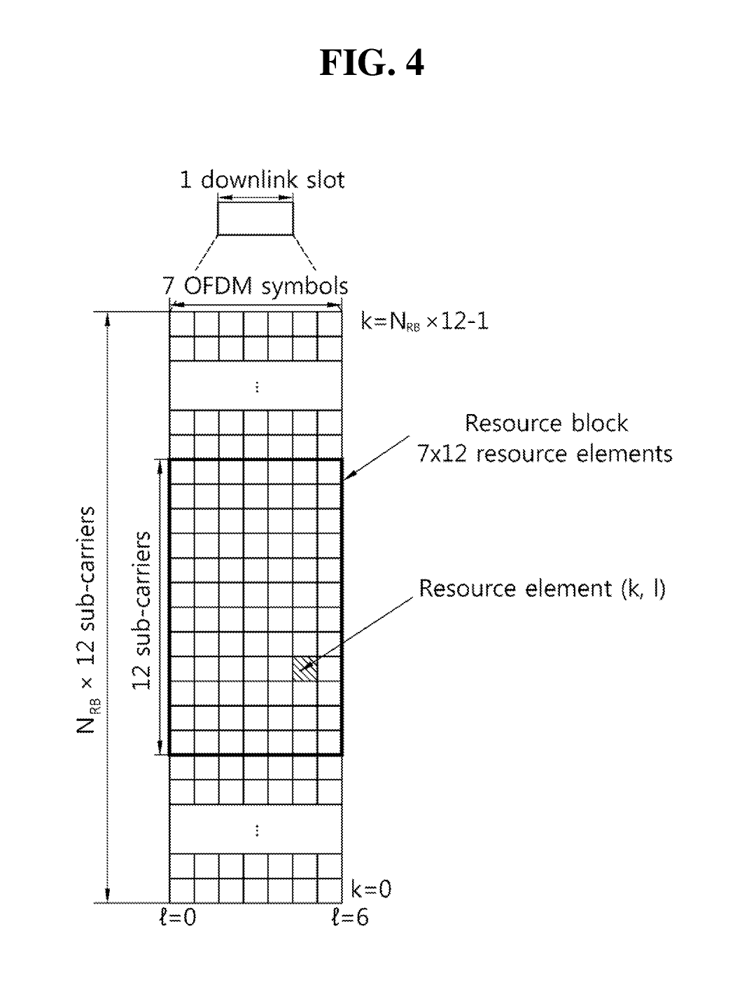

FIG. 4 illustrates an example resource grid for one uplink or downlink slot in 3GPP LTE.

Referring to FIG. 4, the uplink slot includes a plurality of OFDM (orthogonal frequency division multiplexing) symbols in the time domain and NRB resource blocks (RBs) in the frequency domain. For example, in the LTE system, the number of resource blocks (RBs), i.e., N_{RB}, may be one from 6 to 110.

Here, by way of example, one resource block includes 7×12 resource elements that consist of seven OFDM symbols in the time domain and 12 sub-carriers in the frequency domain. However, the number of sub-carriers in the resource block and the number of OFDM symbols are not limited thereto. The number of OFDM symbols in the resource block or the number of sub-carriers may be changed variously. In other words, the number of OFDM symbols may be varied depending on the above-described length of CP. In particular, 3GPP LTE defines one slot as having seven OFDM symbols in the case of CP and six OFDM symbols in the case of extended CP.

OFDM symbol is to represent one symbol period, and depending on system, may also be denoted SC-FDMA symbol, OFDM symbol, or symbol period. The resource block is a unit of resource allocation and includes a plurality of sub-carriers in the frequency domain. The number of resource blocks included in the uplink slot, i.e., NUL, is dependent upon an uplink transmission bandwidth set in a cell. Each element on the resource grid is denoted resource element.

Meanwhile, the number of sub-carriers in one OFDM symbol may be one of 128, 256, 512, 1024, 1536, and 2048.

In 3GPP LTE, the resource grid for one uplink slot shown in FIG. 4 may also apply to the resource grid for the downlink slot.

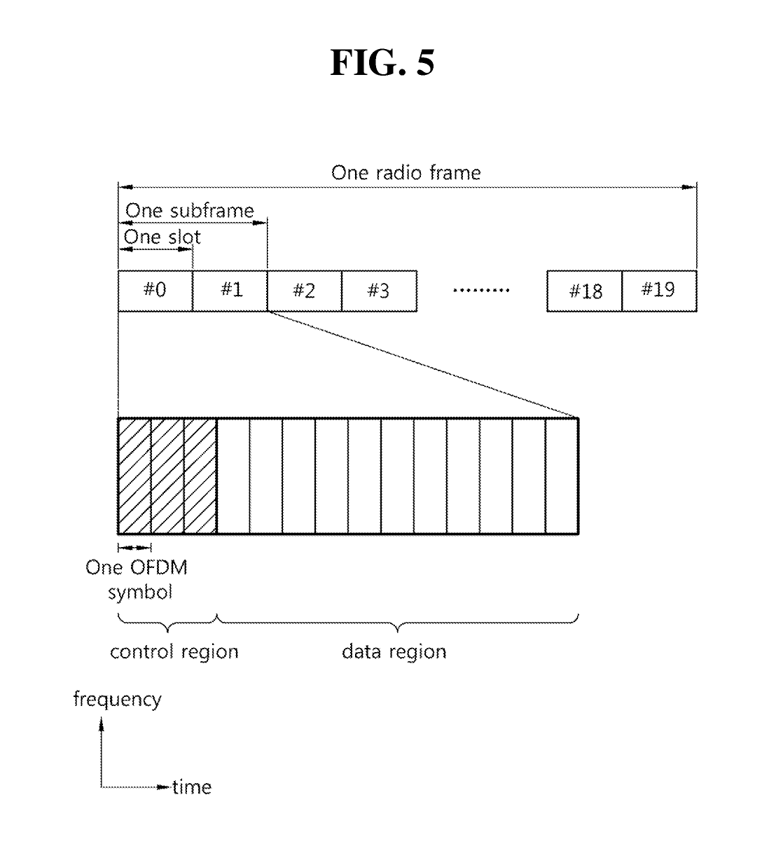

FIG. 5 illustrates the architecture of a downlink sub-frame.

For this, 3GPP TS 36.211 V10.4.0 (2011-12) “Evolved Universal Terrestrial Radio Access (E-UTRA); Physical Channels and Modulation (Release 10)”, Ch. 4 may be referenced.

The radio frame includes 10 sub-frames indexed 0 to 9. One sub-frame includes two consecutive slots. Accordingly, the radio frame includes 20 slots. The time taken for one sub-frame to be transmitted is denoted TTI (transmission time interval). For example, the length of one sub-frame may be lms, and the length of one slot may be 0.5 ms.

One slot may include a plurality of OFDM (orthogonal frequency division multiplexing) symbols in the time domain. OFDM symbol is merely to represent one symbol period in the time domain since 3GPP LTE adopts OFDMA (orthogonal frequency division multiple access) for downlink (DL), and the multiple access scheme or name is not limited thereto. For example, the OFDM symbol may be referred to as SC-FDMA (single carrier-frequency division multiple access) symbol or symbol period.

In FIG. 5, assuming the normal CP, one slot includes seven OFDM symbols, by way of example. However, the number of OFDM symbols included in one slot may vary depending on the length of CP (cyclic prefix). That is, as described above, according to 3GPP TS 36.211 V 10.4.0, one slot includes seven OFDM symbols in the normal CP and six OFDM symbols in the extended CP.

Resource block (RB) is a unit for resource allocation and includes a plurality of sub-carriers in one slot. For example, if one slot includes seven OFDM symbols in the time domain and the resource block includes 12 sub-carriers in the frequency domain, one resource block may include 7×12 resource elements (REs).

The DL (downlink) sub-frame is split into a control region and a data region in the time domain. The control region includes up to first three OFDM symbols in the first slot of the sub-frame. However, the number of OFDM symbols included in the control region may be changed. A PDCCH (physical downlink control channel) and other control channels are assigned to the control region, and a PDSCH is assigned to the data region.

As set forth in 3GPP TS 36.211 V10.4.0, the physical channels in 3GPP LTE may be classified into data channels such as PDSCH (physical downlink shared channel) and PUSCH (physical uplink shared channel) and control channels such as PDCCH (physical downlink control channel), PCFICH (physical control format indicator channel), PHICH (physical hybrid-ARQ indicator channel) and PUCCH (physical uplink control channel).

The PCFICH transmitted in the first OFDM symbol of the sub-frame carries CIF (control format indicator) regarding the number (i.e., size of the control region) of OFDM symbols used for transmission of control channels in the sub-frame. The wireless device first receives the CIF on the PCFICH and then monitors the PDCCH.

Unlike the PDCCH, the PCFICH is transmitted through a fixed PCFICH resource in the sub-frame without using blind decoding.

The PHICH carries an ACK (positive-acknowledgement)/NACK (negative-acknowledgement) signal for a UL HARQ (hybrid automatic repeat request). The ACK/NACK signal for UL (uplink) data on the PUSCH transmitted by the wireless device is sent on the PHICH.

The PBCH (physical broadcast channel) is transmitted in the first four OFDM symbols in the second slot of the first sub-frame of the radio frame. The PBCH carries system information necessary for the wireless device to communicate with the base station, and the system information transmitted through the PBCH is denoted MIB (master information block). In comparison, system information transmitted on the PDSCH indicated by the PDCCH is denoted SIB (system information block).

The PDCCH may carry activation of VoIP (voice over internet protocol) and a set of transmission power control commands for individual UEs in some UE group, resource allocation of an upper layer control message such as a random access response transmitted on the PDSCH, system information on DL-SCH, paging information on PCH, resource allocation information of UL-SCH (uplink shared channel), and resource allocation and transmission format of DL-SCH (downlink-shared channel). A plurality of PDCCHs may be sent in the control region, and the terminal may monitor the plurality of PDCCHs. The PDCCH is transmitted on one CCE (control channel element) or aggregation of some consecutive CCEs. The CCE is a logical allocation unit used for providing a coding rate per radio channel's state to the PDCCH. The CCE corresponds to a plurality of resource element groups. Depending on the relationship between the number of CCEs and coding rates provided by the CCEs, the format of the PDCCH and the possible number of PDCCHs are determined.

The control information transmitted through the PDCCH is denoted downlink control information (DCI). The DCI may include resource allocation of PDSCH (this is also referred to as DL (downlink) grant), resource allocation of PUSCH (this is also referred to as UL (uplink) grant), a set of transmission power control commands for individual UEs in some UE group, and/or activation of VoIP (Voice over Internet Protocol).

The base station determines a PDCCH format according to the DCI to be sent to the terminal and adds a CRC (cyclic redundancy check) to control information. The CRC is masked with a unique identifier (RNTI; radio network temporary identifier) depending on the owner or purpose of the PDCCH. In case the PDCCH is for a specific terminal, the terminal's unique identifier, such as C-RNTI (cell-RNTI), may be masked to the CRC. Or, if the PDCCH is for a paging message, a paging indicator, for example, P-RNTI (paging-RNTI) may be masked to the CRC. If the PDCCH is for a system information block (SIB), a system information identifier, SI-RNTI (system information-RNTI), may be masked to the CRC. In order to indicate a random access response that is a response to the terminal's transmission of a random access preamble, an RA-RNTI (random access-RNTI) may be masked to the CRC.

In 3GPP LTE, blind decoding is used for detecting a PDCCH. The blind decoding is a scheme of identifying whether a PDCCH is its own control channel by demasking a desired identifier to the CRC (cyclic redundancy check) of a received PDCCH (this is referred to as candidate PDCCH) and checking a CRC error. The base station determines a PDCCH format according to the DCI to be sent to the wireless device, then adds a CRC to the DCI, and masks a unique identifier (this is referred to as RNTI (radio network temporary identifier) to the CRC depending on the owner or purpose of the PDCCH.

According to 3GPP TS 36.211 V10.4.0, the uplink channels include a PUSCH, a PUCCH, an SRS (Sounding Reference Signal), and a PRACH (physical random access channel).

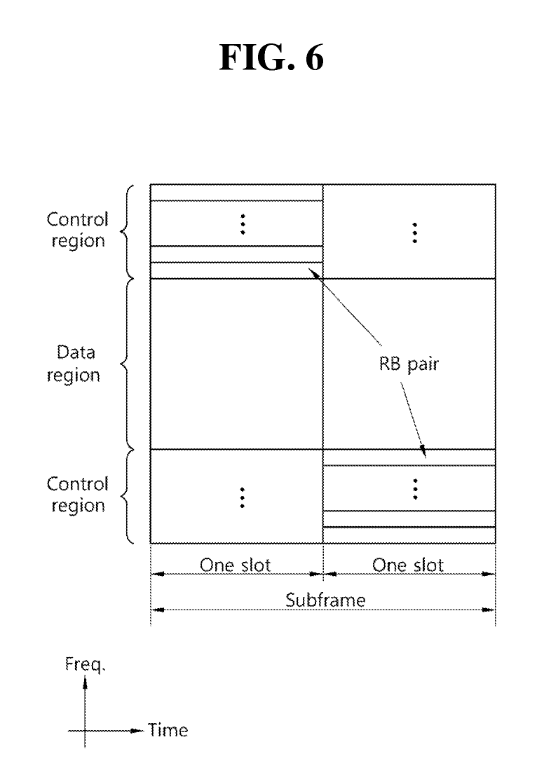

FIG. 6 illustrates the architecture of an uplink sub-frame in 3GPP LTE.

Referring to FIG. 6, the uplink sub-frame may be separated into a control region and a data region in the frequency domain. The control region is assigned a PUCCH (physical uplink control channel) for transmission of uplink control information. The data region is assigned a PUSCH (physical uplink shared channel) for transmission of data (in some cases, control information may also be transmitted).

The PUCCH for one terminal is assigned in resource block (RB) pair in the sub-frame. The resource blocks in the resource block pair take up different sub-carriers in each of the first and second slots. The frequency occupied by the resource blocks in the resource block pair assigned to the PUCCH is varied with respect to a slot boundary. This is referred to as the RB pair assigned to the PUCCH having been frequency-hopped at the slot boundary.

The terminal may obtain a frequency diversity gain by transmitting uplink control information through different sub-carriers over time. m is a location index that indicates a logical frequency domain location of a resource block pair assigned to the PUCCH in the sub-frame.

The uplink control information transmitted on the PUCCH includes an HARQ (hybrid automatic repeat request), an ACK (acknowledgement)/NACK (non-acknowledgement), a CQI (channel quality indicator) indicating a downlink channel state, and an SR (scheduling request) that is an uplink radio resource allocation request.

The PUSCH is mapped with a UL-SCH that is a transport channel. The uplink data transmitted on the PUSCH may be a transport block that is a data block for the UL-SCH transmitted for the TTI. The transport block may be user information. Or, the uplink data may be multiplexed data. The multiplexed data may be data obtained by multiplexing the transport block for the UL-SCH and control information. For example, the control information multiplexed with the data may include a CQI, a PMI (precoding matrix indicator), an HARQ, and an RI (rank indicator). Or, the uplink data may consist only of control information.

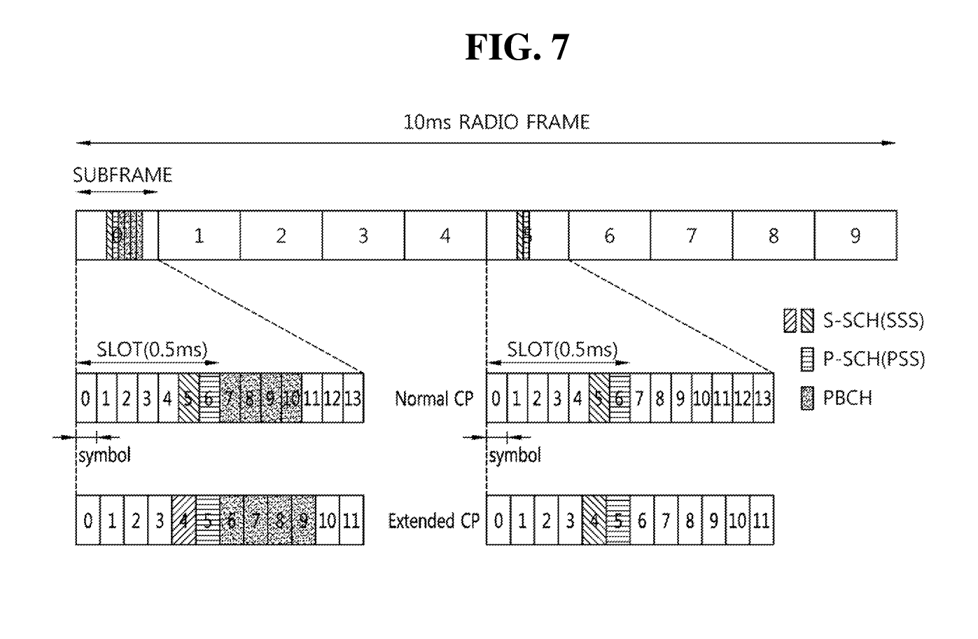

FIG. 7 illustrates a frame structure for transmitting a synchronization signal in an FDD frame in the related art. The slot number and the subframe number start from 0.

The UE may match time and frequency synchronization based on a synchronization signal received from the base station. A synchronization signal of 3GPP LTE-A is used to search the cell and may be divided into a primary synchronization signal (PSS) and a secondary synchronization signal (SSS). The synchronization signal of the 3GPP LTE-A may be described with reference to Phrase 6.11 of 3GPP TS V10.2.0 (2011-06).

The PSS is used to obtain OFDM symbol synchronization or slot synchronization and is associated with a physical layer cell identity (ID). In addition, the SSS is used to obtain frame synchronization. Further, the SSS is used to detect the length of the CP and obtain a physical layer cell group ID.

The synchronization signal may be transmitted in each of subframe #0 and subframe #5 by considering 4.6 ms which is a global system for mobile communication (GSM) frame length for easiness of inter-RAT (radio access technology) measurement and a boundary for the frame may be detected through the SSS. In more detail, in the FDD system, the PSS is transmitted in an 0-th slot and the last OFDM symbol of a 10-th slot and the SSS is transmitted in an OFDM symbol just before the PSS.

The synchronization signal may transmit any one of a total of physical layer cell identities (IDs) through combining three PSSs and 168 SSSs. A physical broadcast channel (PBCH) is transmitted in first four OFDM symbols of a first slot. The SS and the PBCH are transmitted within center 6 RBs in a system bandwidth to allow the UE to perform detection or decoding regardless a transmission bandwidth. A physical channel in which the PSS is transmitted is referred to as P-SCH and a physical channel in which the SSS is transmitted is referred to as S-SCH.

A transmission diversity mode of the SS uses only a single antenna port and is not separately defined in the standard. That is, a single antenna transmission or UE-transparent transmission mode (for example, precoding vector switching (PVS), time switched transmit diversity (TSTD), and cyclic delay diversity)) may be used.

In the PSS, a Zadoff-Chu (ZC) sequence having a length of 63 is defined in a frequency domain and is used as a sequence of the PSS. The ZC sequence is defined by Equation 1 and a sequence element corresponding to a DC subcarrier, that is, n=31 is punctured. In Equation 1, Nzc=63.

[Equation 1]

$${d}_{u} ( n ) = {e}^{- j \frac{π un ( n + 1 )}{{N}_{ZC}}}$$

9 (=72−63) residual subcarriers among center 6 RBs (=72 subcarriers) are continuously transmitted as a value of 0 and facilitate filter design for synchronization. Values of u=25, 29, and 34 are used in Equation 1 in order to define a total of three PSSs. In this case, since 29 and 34 have a conjugate symmetry relationship, two correlations may be simultaneously performed. Herein, the conjugate symmetry means a relationship of Equation 2 given below and a one-shot correlator for u=29 and 34 may be implemented to reduce a total calculation amount by approximately 33.3%.

dᵤ(n)=(−1)ⁿ(d_{N}_{_{zc}}₋ᵤ(n)), when N_{ZC} is even number.

dᵤ(n)=(d_{N}_{_{zc}}₋ᵤ(n)), when N_{ZC} is odd number. [Equation 2]

As the sequence used for the SSS, two m-sequences having a length of 31 are interleaved and used. The SSS may transmit any one of a total of 168 cell group IDs by combining two sequences. m-sequence used as the sequence of the SSS is robust under a frequency selective environment and may reduce a calculation amount by fast m-sequence transform using fast Hadamard transform. Further, constituting the SSS by two short codes, that is, two m-sequences is proposed to reduce the calculation amount of the UE.

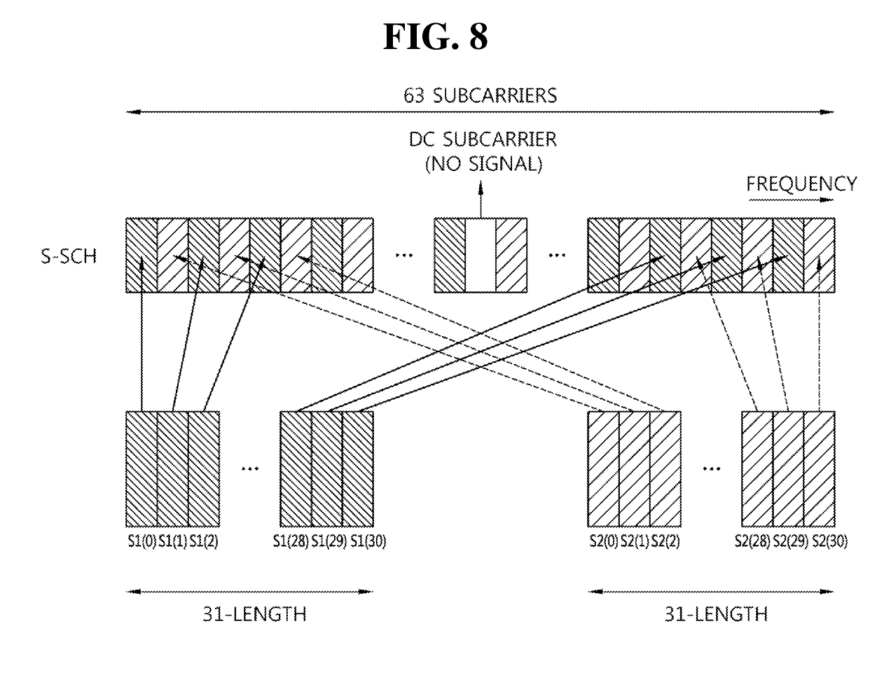

FIG. 8 illustrates that two sequences in a logic region are interleaved and mapped in a physical region.

Referring to FIG. 8, when two m-sequences used for generating an SSS code are defined as S1 and S2, respectively, when the SSS of subframe 0 transmtis the cell group identity by combination of two signals (S1, S2), the SSS of subframe 5 swaps the combination to (S2, S1) and transmits (S2, S1) to distinguish a 10 ms frame boundary. In this case, the used SSS code uses a generate polynominal of x⁵+x²+1 and a total of 31 codes may be generated through different circular shifts.

In order to improve receiving performance, two PSS based different sequences are defined to be scrambled to the SSS, however, scrambled are scrambled to S1 and S2 in different sequences. Thereafter, an S1-based scrambling code is defined to perform scrambling to S2. In this case, the code of the SSS is swapped by the unit of 5 ms, but a PSS-based scrambling code is not swapped. The PSS-based scrambling code is defined as 6 circular shift versions according to a PSS index in the m-sequence generated from the generate polynominal of x⁵+x³+1 and the S1-based scrambling code may be defined as 8 circular shift versions according to an S1 index in an m-sequence generated from a poynominal of x⁵+x⁴+x²+x¹+1.

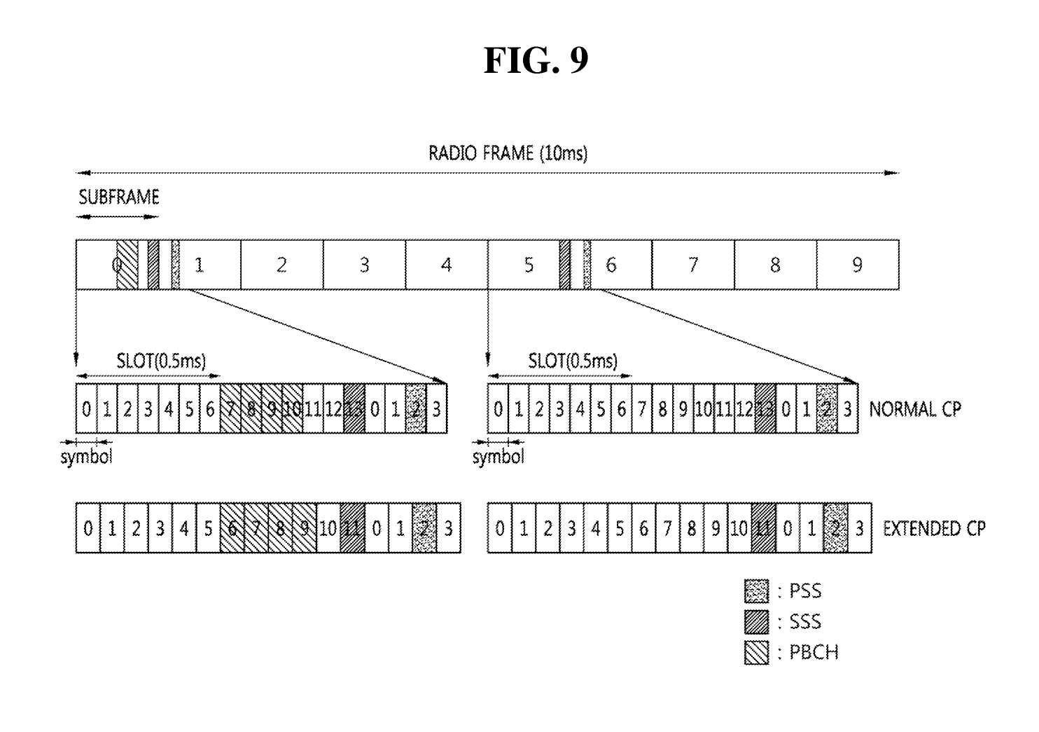

FIG. 9 illustrates an example of a frame structure in which a synchronization signal is transmitted in a TDD frame in the related art.

In the TDD frame, the PSS is transmitted in a third slot and a third OFDM symbol of a 13-th slot. The SSS is transmitted before 3 OFDM symbols in the OFDM symbol in which the PSS is transmitted. The PBCH is transmitted in first 4 OFDM symbols of a second slot of a first subframe.

Hereinafter, one aspect of the present invention will be described.

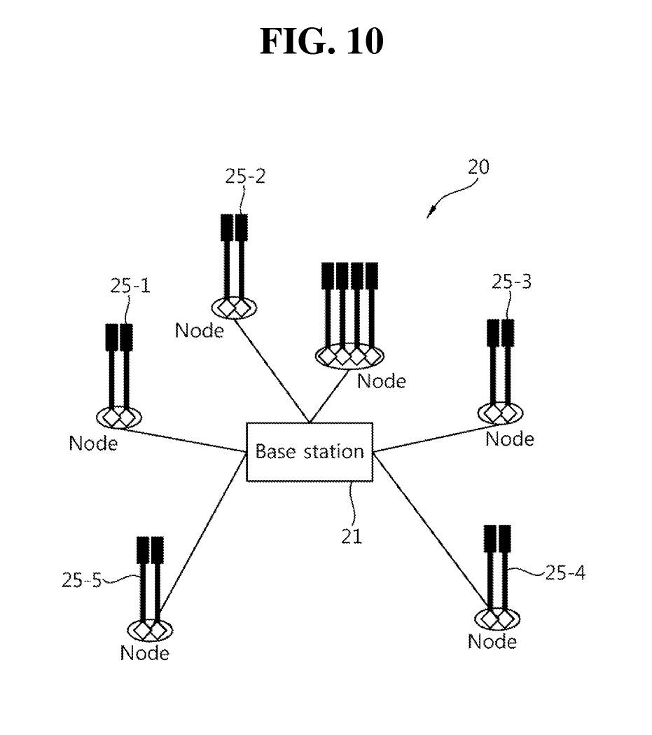

FIG. 10 illustrates one example of the distributed antenna system.

First, a DAS system means a system that manages antennas that spread at various positions in the cell in a single base station unlike a centralized antenna system (CAS) in which base station (BS, BTS, Node-B, and eNode-B) antennas are crowded at the center of the cell. The DAS system is distinguished from a femto cell or a pico cell in that multiple antennas constitute one cell. An initial usage of the DAS system is a usage of relay (or, repetition) by further installing the antenna in order to cover a range region. However, when you look the DAS system at large, the DAS system may be regarded as one kind of multiple input multiple output (MIMO) system in that the base station antennas simultaneously transmit and receive multiple data to support one or multiple users. From the viewpoint of the MIMO system, the DAS has an advantage that communication performance having relatively uniform quality is secured regardless of high power efficiency acquired by a decrease in distance between a user and an antenna as compared with the CAS, a high channel capacity due to correlation and interference between base station antennas, which is low, and the position of the user in the cell.

As known with reference to FIG. 10, the distributed antenna system 20 may be constituted by one base station 21 and a plurality of nodes 25-1, 25-2, 25-3, 25-4, and 25-5.

The antenna nodes 25-1, 25-2, 25-3, 25-4, and 25-4 are connected with the base station through a wired/wireless scheme and may include one or a plurality of antennas. That is, the plurality of antenna nodes 25-1, 25-2, 25-3, 25-4, and 25-5 may be managed by one base station 21. In general, antennas that belong to one antenna node may a characteristic in a spot in which a distance between antennas which are closest is regionally similar within several meters. In the existing DAS technologies, there are a lot of technologies in which the antenna node is be regarded to be the same as the antenna or both are not distinguished from each other, but a relationship between both the antenna node and the antenna should be definitely defined in order to actually operate the DAS.

Although it has been described that the respective nodes 25-1, 25-2, 25-3, 25-4, and 25-5 illustrated in FIG. 10 are the antenna nodes, each node may be any one of the base station, the Node-B, the eNode-B, a pico cell eNb (PeNB), a home enb (HeNB), a radio remote head (RRH), a relay station (RS) or a repater, and a distributed antenna. At least one antenna may be installed in one node. Further, the node may be called a point. In the following specification, the node means antenna groups that are spaced apart from each other at a predetermined interval. That is, in the following specification, it is assumed that each node physically means the RRH. However, the present invention is not limited thereto and the node may be defined as a predetermined antenna group regardless of a physical interval. For example, by considering that the base station constituted by a plurality of cross polarized antennas is constituted by a node constituted by horizontally polarized antennas and a node constituted by vertically polarized antennas, the present invention may be applied. Further, the present invention may be applied when each node is the pico cell or the femto cell of which cell coverage is smaller than a macro cell, that is, even in a multiple-cell system. In the following description, the antenna may be substituted with an antenna port, a virtual antenna, an antenna group, and the like as well as a physical antenna.

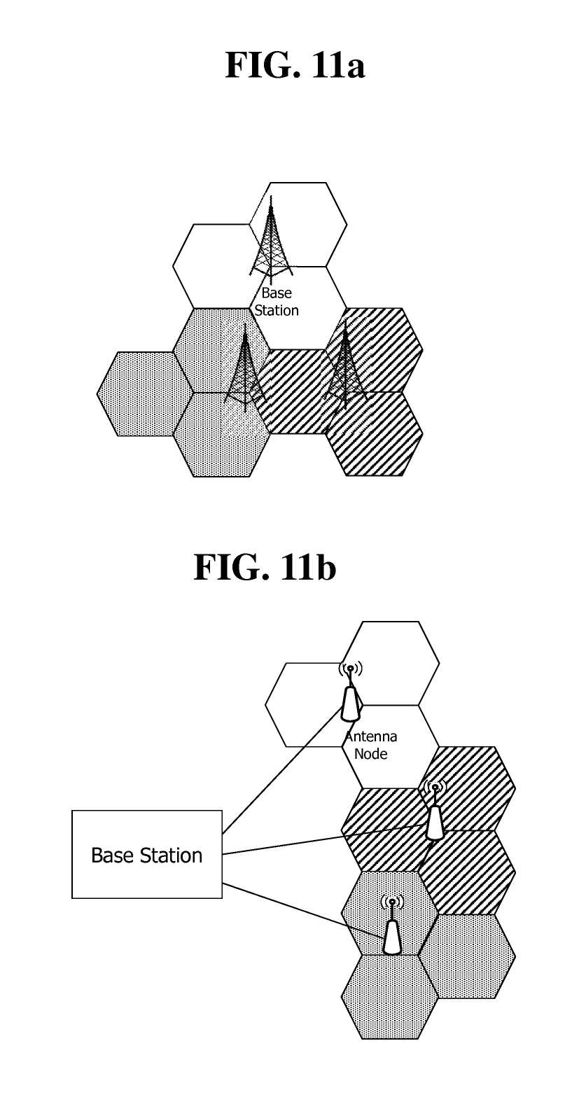

FIG. 11 illustrates advantages of the distributed antenna system.

As illustrated in FIG. 11A, in an existing cellular system, one base station controls for example, three sectors, and each base station is connected with a control station (for example, BSC, RNC) though a backbone network.

However, as illustrated in FIG. 11B, each antenna node is disposed for each area and the base station may be geographically collected at one place. As a result, there is an advantage of reducing costs for lands and buildings to install the base station. Further, there is an advantage of easily maintaining and managing the base station at one place. Further, the backbone network of the base station may be easily managed.

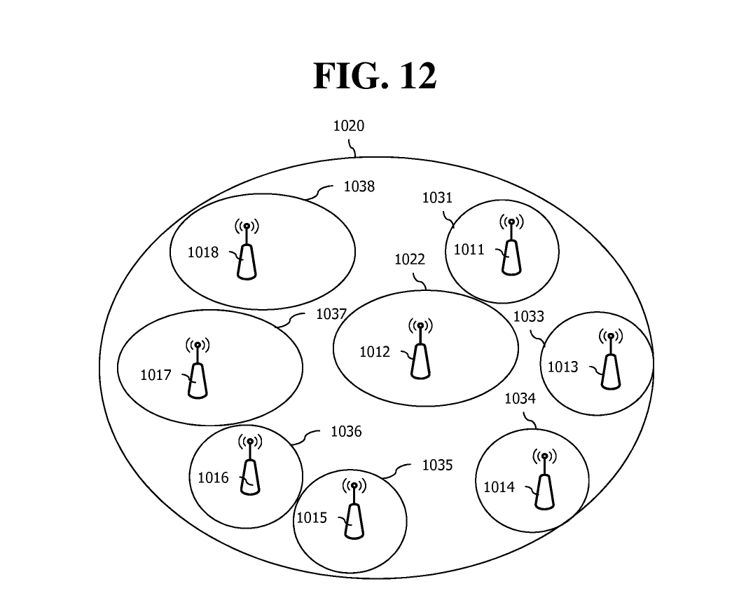

FIG. 12 illustrates an operation example of a distributed antenna system.

Referring to FIG. 12, when a cell is configured by using antenna nodes 1011, 1012, 1013, 1014, 1015, 1016, 1017, and 1018, a cell area may be changed according to a use object.

That is, if necessary, a plurality of antenna nodes 1011, 1012, 1013, 1014, 1015, 1016, 1017, and 1018 may operate like as a part of one cell 1020. In this case, since the cell 1020 covers a wide area, the cell 1020 may be referred to as a wide cell (alternatively, large cell), a macro cell, or a metro cell. Notably, each antenna node may receive a separate node identifier (ID) and operate like as some antenna sets in the cell without a separate node ID. In this case, the distributed antenna system (DAS) of FIG. 11 may be referred to as a distributed multi node system (DMNS) forming one cell.

Further, if necessary, the plurality of antenna nodes 1011, 1012, 1013, 1014, 1015, 1016, 1017, and 1018 may form respective cells 1031, 1032, 1033, 1034, 1035, 1036, 1037, and 1038. In this case, each of the cells 1031, 1032, 1033, 1034, 1035, 1036, 1037, and 1038 may be referred to as a small scale cell (alternatively, a small cell), a femto cell, or a pico cell because the coverage is limited to a partial area. In this case, the DAS of FIG. 11 may be a multi cell system.

Meanwhile, if necessary, the plurality of antenna nodes 1011, 1012, 1013, 1014, 1015, 1016, 1017, and 1018 may form one cell 1020 and simultaneously further form respective cells 1031, 1032, 1033, 1034, 1035, 1036, 1037, and 1038. As such, the plurality of antenna nodes forms one cell 1020 to be a wide cell (alternatively, large cell) or a macro cell. Further, the plurality of antenna nodes forms the respective cells 1031, 1032, 1033, 1034, 1035, 1036, 1037, and 1038 to be a small scale cell (alternatively, a small cell), a femto cell, or a pico cell having a small coverage. As such, when the plurality of cells is configured to be overlaid according to the coverage, the plurality of cells may be referred to as a multi-tier network.

Meanwhile, when the cell area is freely changed, problems such as interference, efficiency of power consumption, and elimination of the shadow area may be overcome, and as a result, it is effective when a UE-based service is provided. For example, in terms of UE moving at a high speed, since it is advantageous that a mobility report (that is, tracking update (TA) or handover) does not frequently occur, it is effective that the coverage of the cell is wide. On the contrary, in terms of UE receiving large-capacity data while moving at a low speed, since it is advantageous that the effect on the interference is minimized, a cell in a small area may be more efficient.

As described above, according to an embodiment of the present invention, if necessary, the plurality of antenna nodes 1011, 1012, 1013, 1014, 1015, 1016, 1017, and 1018 may form one cell 1020 and simultaneously further form respective cells 1031, 1032, 1033, 1034, 1035, 1036, 1037, and 1038.

Meanwhile, as such, when the coverage of the cell formed by each antenna node is changeable if necessary, an existing radio frame needs to be improved. That is, in the existing system, a slot is configured by selecting any one of the extended CP and the normal CP, and thereafter, as illustrated in FIGS. 4 and 5, may be applied to all the subframes. Furthermore, the slot is applied up to all the radio frames. However, in the case of the aforementioned small scale cell (alternatively, a small cell), the femto cell, or the pico cell having a small coverage, since the effect on interference by a multi-path is small, inter-symbol interference (ISI) may be very low. Accordingly, hereinafter, a improved frame structured for the cell having the small coverage needs to be elastically and dynamically changed. Hereinafter, many embodiments for the method of elastically and dynamically changing the frame structure will be described.

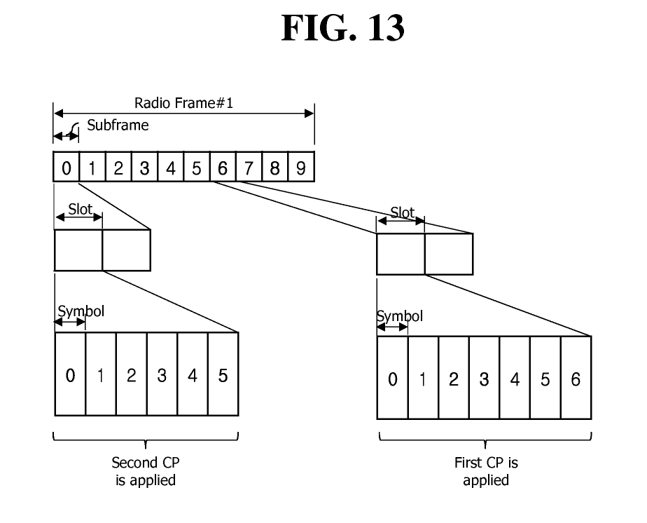

FIG. 13 is an exemplary diagram illustrating a radio frame structure according to the embodiment of the present invention.

Referring to FIG. 13, radio frames including ten subframes are illustrated. In this case, according to the embodiment of the present invention, in each subframe in the radio frame, different CPs are applied, and as a result, the number of OFDM symbols which may be included in each subframe may vary.

In detail, a 0-th (index 0) subframe of the radio frame illustrated in FIG. 13 applies a second CP and a 6-th (index 6) subframe may apply a first CP.

Meanwhile, as such, when the CP to be applied varies for each subframe, for the existing UE which does not recognize the improved frame according to the embodiment of the present invention, there is a consideration. That is, in an exiting LTE system, as described with reference to FIGS. 7 to 9, through synchronization channels existing in 0 and 5-th subframes, a CP type applied to the entire radio frame is estimated and defined to be equally applied to the entire radio frame.

Accordingly, it is advantageous that the CP applied to at least 0-th to 5-th subframes are equally maintained. Therefore, in an example illustrated in FIG. 13, the second CP is applied from the 0-th (index 0) subframe to the 5-th (index 5) subframe, and the first CP may be applied from the 6-th (index 6) subframe.

Meanwhile, the aforementioned first CP may be for example, an extended CP and the second CP may be a normal CP. As such, as the first CP, for example, the extended CP is applied, and as a result, the 0-th subframe having a relative small number of OFDM symbols may be allocated for a wide cell (alternatively, large cell) or a macro cell covering a wide area. Further, as the first CP, the normal CP is applied, and as a result, the 6-th subframe having a relative large number of OFDM symbols may be allocated for a small scale cell (alternatively, small cell), a femto cell, or a pico cell having a small coverage.

Unlike this, the first CP may be a shortened CP (alternatively, short CP) having a length smaller than the length of the normal CP and the second CP may be the normal CP. The shortened CP (alternatively, short CP) may include more OFDM symbols in one subframe than the normal CP. The reason why the shortened CP (alternatively, short CP) may be used is that in the case of the small scale cell (alternatively, small cell), the femto cell, or the pico cell having a small coverage, a channel environment is very good and thus inter-symbol interference (ISI) may be low.

Meanwhile, it is described above that the first CP or the second CP is applied to each subframe in the radio frame, but unlike this, a plurality of CPs having different lengths may be applied. For example, the second CP is applied in the 0-th subframe, the first CP is applied to the 6-th subframe, a third CP is applied in the 7-th subframe, and a fourth CP may be applied to the 8-th subframe. Herein, the first CP may be for example, the extended CP, the second CP may be the normal CP, the third CP may be the shortened CP, and the fourth CP may be a CP having a length of 0 (that is, there is no CP).

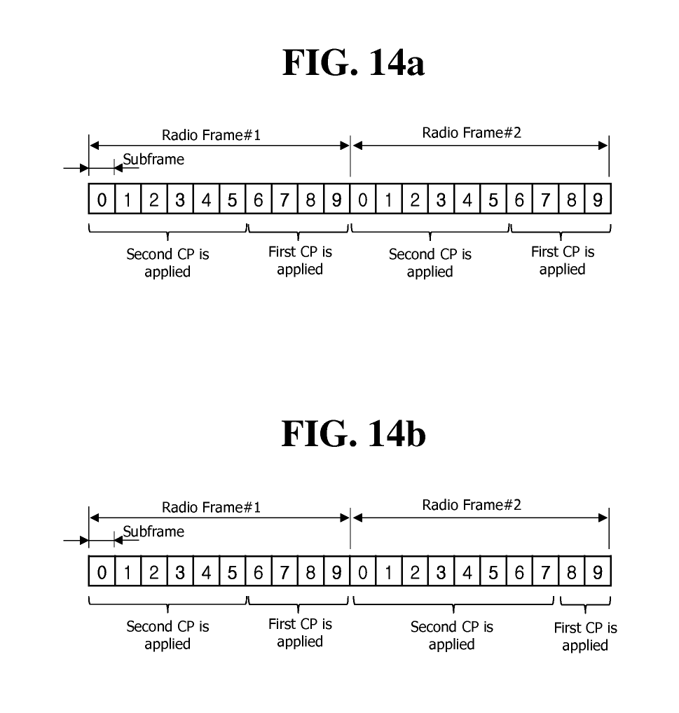

FIG. 14 is an exemplary diagram illustrating a radio frame structure according to another embodiment of the present invention.

First, as illustrated in FIG. 14B, the radio frames may be equally configured. For example, in radio frame 1 and radio frame 2, equally, the second CP is applied to 0-th to 5-th subframes and the first CP may be applied to 6-th to 9-th subframes.

Further, as illustrated in FIG. 14B, the radio frames may be differently configured. For example, the second CP is applied to the 0-th to 5-th subframes of the radio frame 1 and the first CP is applied to the 6-th to 9-th subframes, while the second CP is applied to the 0-th to 7-th subframes of the radio frame 2 and the first CP may be applied to the 8-th and 9-th subframes.

Hereinabove, the method of varying the CP to be applied for each subframe or for each radio frame is described. Hereinafter, a method of recognizing the subframe or the radio frame to which the different CPs are applied by the UE will be described.

First, as a method performed without additional control information, the UE may automatically recognize a CP type applied to the remaining subframe according to a CP type applied to a specific subframe. For example, as described above, the UE in the existing LTE system may determine a CP type through the SSS transmitted on the 0-th and 5-th subframes. In this case, the types of CPs applied to the 0-th and 5-th subframes need to be the same as each other, and as a result, the UE may also determine a CP type applied to the remaining subframe according to the CP types applied to the 0-th and 5-th subframes. In more detail, when the CP types applied to the 0-th and 5-th subframes is the type of first CP, the UE may determine the remaining subframe in the radio frame as the same first type. However, when the CP types applied to the 0-th and 5-th subframes is another type other than the first type, for example, the second type, the UE may determine the 0-th and 5-th subframes as another type and the remaining subframe as the first type.

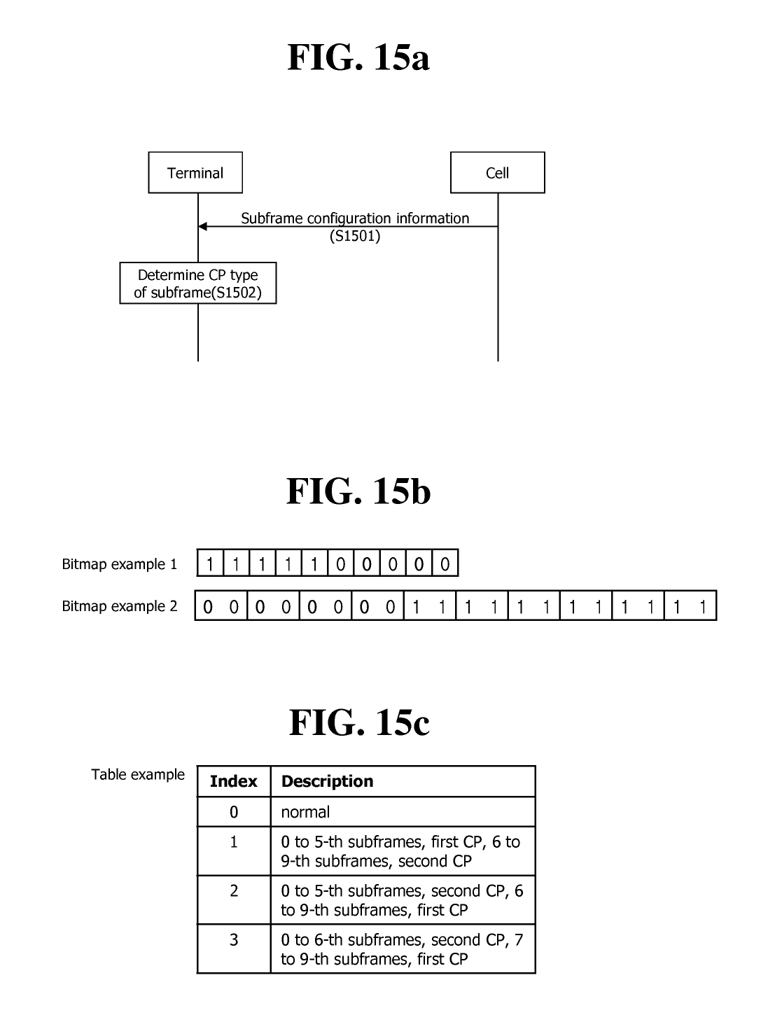

Next, a method of determining a CP type applied to the subframe or the radio frame by the UE through the additional control information, for example, subframe configuration information will be described with reference to FIG. 15.

FIG. 15 illustrates a method of using subframe configuration information according to an embodiment of the present invention.

First, as illustrated in FIG. 15A, a cell transmits the subframe configuration information to the UE. Here, the cell transmitting the subframe configuration information may be a wide cell (alternatively, large cell) or a macro cell which is formed by the plurality of antenna nodes described above. Alternatively, the cell may be a small scale cell (alternatively, small cell), a femto cell, or a pico cell formed by each antenna node.

Then, the UE may determine a CP type applied to the subframe according to the subframe configuration information (S1502).

Meanwhile, as illustrated in FIG. 15B, the subframe configuration information may be a bit map indicating a CP type applied to each subframe. According to Example 1 of the illustrated bit map, each bit indicates the CP type applied to each subframe. Here, for example, bit 0 is referred to as the first CP and bit 1 may be referred to as the second CP. In this case, 10 bits may be required in order to refer to all of ten subframes. Further, according to Example 1 of the illustrated bit map, the CP type applied to each subframe is indicated by a unit of 2 bits. A maximum of four CP types may be designated according to 2 bits. When maximum of four CP types are designated, for example, bit 00 is referred to as the first CP, bit 01 is referred to as the second CP, bit 10 is referred to as the third CP, and bit 11 may be referred to as the fourth CP. However, only three CP types are indicated, for example, bit 00 indicates the first CP, bit 01 indicates the second CP, and bit 10 may indicate the third CP.

Meanwhile, as illustrated in FIG. 15b, the subframe configuration information may indicate a specific index in a table.

For example, as illustrated in FIG. 15c, index 0 may follow the CP type of 0-th and 5-th subframes like a normal configuration, that is, an existing system, index 1 may indicate the first CP of the 0-th to 5-th subframes and the second CP of the 6-th to 9-th subframes, index 2 may indicate the second CP of the 0-th to 5-th subframes and the first CP of the 6-th to 9-th subframes, and index 3 may indicate the second CP of the 0-th to 6-th subframes and the first CP of the 7-th to 9-th subframes. It is cautious that indexes are just exemplified and may be variously modified.

Meanwhile, although not illustrated, but as a modified example, there may be a method of displacing consecutive CP types. That is, the 0-th subframe and the same CP type are consecutively disposed and an index or a number of the subframe to which the different CP type is applied may be transferred.

As another modified example, supportable CP type sets and indexes may be used. For example, when the type of the 0-th to 5-th subframes is configured by the normal CP, index 1 indicates that the all subframes are the normal CP, index 1 may indicate that only the 9-th subframe is the extended CP and the remaining subframes are the normal CP. Further, for example, when the 0-th and 5-th subframe types are configured by the extended CP, index 1 indicates that the 0-th to 5-th subframes are the extend CP and the remaining subframes are the normal CP, and index 2 may indicate that the 0-th to 8-th subframe are the extended CP and the remaining subframes are the normal CP.

Meanwhile, the aforementioned additional control information, that is, the subframe configuration information may be transmitted to the UE through a separate control signal or through a control channel.

First, the separate signal may be for example, a control signal for each UE (for example, a UE specific control signal) or a common control signal. By the control signal for each UE (for example, the UE specific control signal), the subframe configuration information may be transmitted to only the specific UE, and by the common control signal, the subframe configuration information is broadcasted to all the UEs included in the wide cell to be transmitted.

Meanwhile, when describing the transmission through the control channel, an additional signal may be added to a predetermined position of the control channel. In this case, the additional signal is combined with another function (for example, synchronization obtain from the antenna node) to be used. To this end, the position of the additional signal may be the 0-th and 5-th subframes in the case of the LTE system. As such, the UE may obtain the CP type in all the frames by using the additional signal in a process of obtaining the CP type in the existing LTE. Here, in the 0-th and 5-th subframes, positioning the additional signal is just exemplified, and the additional signal may be positioned even at another place other than the 0-th and 5-th subframes. That is, a basic CP type is determined in a specific frame (alternatively, a specific subframe) and information for the CP type to be applied to another frame (alternatively, another subframe) may be separately determined based on the basic CP type. The method may provide the CP for each UE (UE specific CP) and maximize system efficiency therethrough.

Up to now, in order to elastically operate the cell by using the antenna node in the DAS, methods of dynamically changing the frame will be described. By the method, a configuration of the base station and/or the cell may be actively changed according to the number of UES in the corresponding area, a data traffic required amount, movement of a target UE, and the like. Further, in the frame to be configured in any antenna node, a plurality of CP types may be applied, thereby maximizing the system efficiency.

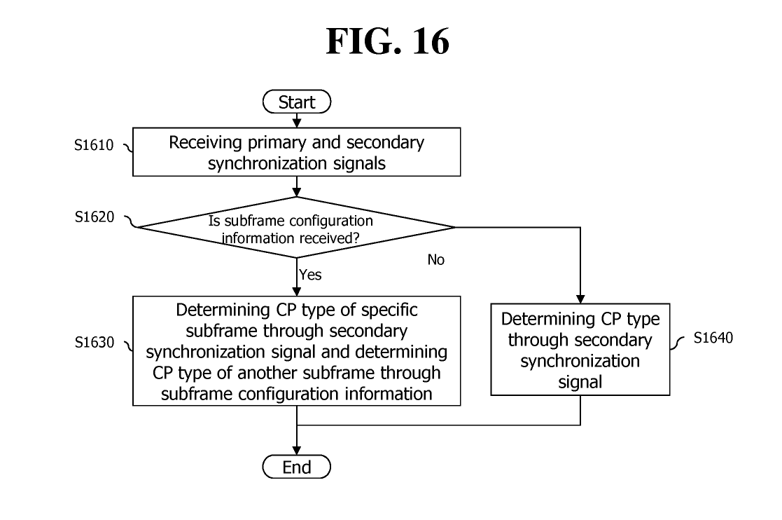

FIG. 16 is a flowchart illustrating a process of determining a subframe configuration by the UE according to an embodiment of the present invention.

As illustrated in FIG. 16, the UE receives a primary synchronization signal (PSS) and a secondary synchronization signal (SSS) from the cell by a distributed antenna system (S1610).

Next, when subframe configuration information is additionally received (S1620), the UE determines a cyclic prefix (CP) type applied to a specific subframe in the radio frame through the SSS and may determine the CP type applied to other subframes in the radio frame through the subframe configuration information (S1630).

However, when the additional subframe configuration information is not received in step S1620, the UE determines the CP type through the SSS (S1640). As described above, the step means that the UE automatically determines the CP type applied to the remaining subframes according to the CP type applied to the specific subframe. For example, as described above, when the CP type applied to the 0-th and 5-th subframes is another type other than the first type, for example, the second type, the UE may determine the 0-th to 5-th subframes as another type and the remaining subframe as the first type.

The embodiments of the present invention may be implemented through various means. For example, the embodiments of the present invention may be implemented by hardware, firmware, software, or combinations thereof.

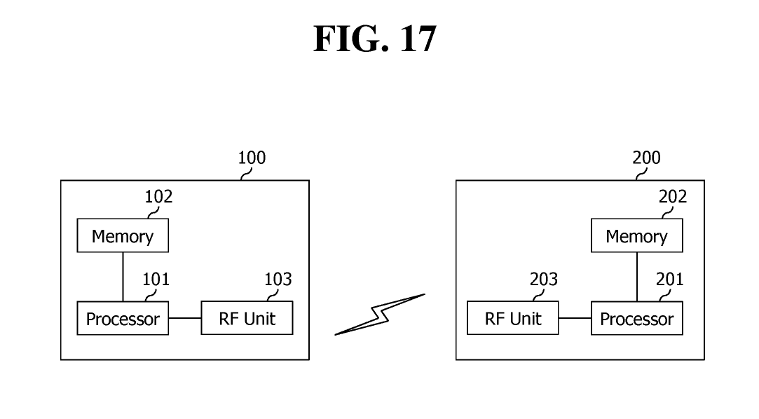

In detail, this will be described with reference to FIG. 17.

FIG. 17 is a block diagram showing a wireless communication system to implement an embodiment of the present invention.

The base station 200 a processor 201, memory 202, and an RF unit 203. The memory 202 is connected to the processor 201 and configured to store various information used for the operations for the processor 201. The RF unit 203 is connected to the processor 201 and configured to send and/or receive a radio signal. The processor 201 implements the proposed functions, processed, and/or methods. In the described embodiments, the operation of the eNodeB may be implemented by the processor 201.

A wireless device 100 includes a processor 101, memory 102, and a radio frequency (RF) unit 103. The memory 102 is connected to the processor 101 and configured to store various information used for the operations for the processor 101. The RF unit 103 is connected to the processor 101 and configured to send and/or receive a radio signal. The processor 101 implements the proposed functions, processed, and/or methods. In the described embodiments, the operation of the wireless device may be implemented by the processor 101.

The processor may include Application-Specific Integrated Circuits (ASICs), other chipsets, logic circuits, and/or data processors. The memory may include Read-Only Memory (ROM), random access Memory (RAM), flash memory, memory cards, storage media and/or other storage devices. The RF unit may include a baseband circuit for processing a radio signal. When the above-described embodiment is implemented in software, the above-described scheme may be implemented using a module (process or function) which performs the above function. The module may be stored in the memory and executed by the processor. The memory may be disposed to the processor internally or externally and connected to the processor using a variety of well-known means.

In the above exemplary systems, although the methods have been described on the basis of the flowcharts using a series of the steps or blocks, the present invention is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present invention. In the above exemplary systems, although the methods have been described on the basis of the flowcharts using a series of the steps or blocks, the present invention is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present invention.

The present invention may be used in a terminal, a base station, or other equipment of a wireless mobile communication system.

1. A method for determining subframes, the method performed by a user equipment (UE) and comprising:
receiving from a base station subframe configuration information on a plurality of subframes, wherein each of the plurality of subframes includes a plurality of OFDM symbols, each of the plurality of OFDM symbols includes a cyclic prefix (CP) that is equal to or longer than zero in length, and the CP length is the same in a plurality of OFDM symbols of the subframe; and
determining a CP length of a subframe to be received based on the subframe configuration information,
wherein the subframe configuration information indicates that the CP length of each of the plurality of subframes is any one of a first CP length and a second CP length.

2. The method of claim 1, wherein the subframe configuration information includes a plurality of bits and each of the plurality of bits indicates the CP length of each of the plurality of subframes.

3. The method of claim 1, further comprising:
receiving subframe pattern information from the base station,
wherein the subframe pattern information includes a plurality of patterns for the CP lengths of the plurality of subframes and the subframe configuration information indicates one of the plurality of patterns.

4. The method of claim 1, wherein the first CP length is longer than the second CP length.

5. A method for determining subframes in a distributed antenna system, the method performed by a user equipment (UE) and comprising:
receiving a primary synchronization signal (PSS) and a secondary synchronization signal (SSS) from a cell by the distributed antenna system; and
receiving subframe configuration information,
wherein a CP type applied to each of a specific subframe and other subframes in a radio frame is determined based on the SSS and the subframe configuration information.

6. The method of claim 5, wherein the CP type applied to the specific frame is different from the CP type applied to the other subframes.

7. The method of claim 5, wherein when the CP types are different from each other, the specific subframe is used for a first cell and the other subframes are used for a second cell.

8. The method of claim 7, wherein:
the first cell is a cell formed by a plurality of distributed antenna nodes, and
the second cell is a cell formed by each antenna node.

9. The method of claim 5, wherein the subframe configuration information includes a bitmap indicating the applied CP type.

10. The method of claim 5, wherein the subframe configuration information is an index indicating at least one in a table for the applied CP type.

11. A user equipment (UE) for a distributed antenna system, comprising:
a radio frequency (RF) unit which transmits or receives a radio signal; and
a processor connected with the RF unit,
wherein the processor unit is configured to acquire a type of a cyclic prefix (CP) applied to a subframe in the radio frame, identify that a first type of CP is applied to a specific subframe and a second type of CP is applied to other subframe in a radio frame, then identify the specific frame as a first cell and the other subframe as a second cell.

12. The UE of claim 11, wherein:
the first cell is a cell formed by a plurality of distributed antenna nodes, and
the second cell is a cell formed by each antenna node.

13. The UE of claim 11, wherein the CP type is acquired through a secondary synchronization signal and subframe configuration information received from a cell by the distributed antenna system.

14. A base station in a distributed antenna system, comprising:
a processor unit controlling each antenna node,
wherein the processor unit controls the each antenna node thereby forming a first cell by at least one antenna node and forming a second cell by antenna nodes together, and
wherein the processor unit is configured to apply a first type of CP to a specific subframe in a radio frame to be used for a first cell and a second type of CP to other subframes to be used for a second cell.

15. The base station of claim 14, wherein the processor is further configured to transmit subframe configuration information for the applied CP type through at least one antenna node.

16. The base station of claim 14, wherein the antenna node through which the subframe configuration information is transmitted is an antenna node that forms the second cell.

17. The base station of claim 14, wherein the antenna node that forms the first cell is an antenna node that performs a related operation of tracking area update or transmits system information.
